(19) United States
(12) Patent Application Publication
(10) Pub. No.: US 2023/0318152 A1
(43) Pub. Date: Oct. 5, 2023

(54) BATTERY CELL

(71) Applicant: Rivian IP Holdings, LLC, Irvine, CA (US)

(72) Inventors: Sanket Sudam Mundhe, Fremont, CA (US); Susheel Teja Gogineni, Sunnyvale, CA (US)

(73) Assignee: Rivian IP Holdings, LLC, Irvine, CA (US)

(21) Appl. No.: 17/711,392

(22) Filed: Apr. 1, 2022

(51) Int. Cl. H01M 50/54; H01M 50/547; H01M 10/0585

(52) U.S. Cl. CPC H01M 50/54; H01M 50/547; H01M 10/0585; H01M 2220/20

(57) ABSTRACT

Provided herein is a battery cell. The battery cell can include a stack structure comprising a first end and a second end. The stack structure can include an anode layer between a first end and a second end. The stack structure can include a cathode layer between the first end and the second end. The stack structure can include an anode tab on a first area of the first end. The anode tab can be electrically coupled with the anode layer to define a negative terminal. The stack structure can include a cathode tab on a second area of the second end. The cathode tab can be electrically coupled with the cathode layer to define a positive terminal.

### BACKGROUND

A battery can include electrochemical cells to store electrical power to convey to other components electrically coupled therewith.

### SUMMARY

The present disclosure is directed to a stack structure for a battery cell. The stack structure can include an alternating set of anode layers and cathode layers. The stack structure can also be divided into multiple section. In each section, the stack structure for the battery cell have a set of anode tabs on one end toward one edge and a set of cathode tabs on an opposite end towards the opposite edge. The set of anode tabs and the set cathode tabs can form a diagonally opposite tab configuration (e.g., in an “x” shape). This configuration can result in a uniform electromechanical current production, because the electrical current flows in a diagonal manner through the battery cell. The uniform current production in turn can yield a more evenly distributed of thermal energy throughout the stack structure, increasing the life span of the battery cell.

At least one aspect is directed to a battery cell. The battery cell can include a stack structure comprising a first end and a second end. The first end can include a first area and a second area, a first area of the second end aligned with the first area of the first end and a second area of the second end aligned with the second area of the first end. The stack structure can include an anode layer between the first end and the second end. The stack structure can include a cathode layer between the first end and the second end. The stack structure can include an anode tab on the first area of the first end. The anode tab can be electrically coupled with the anode layer to define at least part of a negative terminal. The stack structure can include a cathode tab on the second area of the second end. The cathode tab can be electrically coupled with the cathode layer to define at least part of a positive terminal.

At least one aspect is directed to a method of manufacturing a battery cell. The method can include disposing an anode layer between a first end and a second end of a stack structure. The method can include disposing a cathode layer between the first end and the second end of the stack structure. The method can include defining an anode tab on a first area of the first end aligned with a first area of the second end. The anode tab can be electrically coupled with the anode layer to define at least part of a negative terminal. The method can include defining a cathode tab on a second area of the second end aligned with a second area of the first tab. The cathode tab can be electrically coupled with the cathode layer to define at least part of a positive terminal.

At least one aspect is directed to an electric vehicle. The electric vehicle can include one or more components. The electric vehicle can include a battery pack to power the one or more components. The electric vehicle can include a housing arranged in the battery pack. The housing can define a cavity. The electrical vehicle can include a stack structure comprising a first end and a second end. The first end can include a first area and a second area, a first area of the second end aligned with the first area of the first end and a second area of the second end aligned with the second area of the first end. The stack structure can include an anode layer between the first end and the second end. The stack structure can include a cathode layer between the first end and the second end. The stack structure can include an anode tab on the first area of the first end. The anode tab can be electrically coupled with the anode layer to define at least part of a negative terminal. The stack structure can include a cathode tab on the second area of the second end. The cathode tab can be electrically coupled with the cathode layer to define at least part of a positive terminal.

At least one aspect is directed to a method of providing a battery cell. The method can include providing a battery cell. The battery cell can include a stack structure comprising a first end and a second end. The first end can include a first area and a second area, a first area of the second end aligned with the first area of the first end and a second area of the second end aligned with the second area of the first end. The stack structure can include an anode layer between the first end and the second end. The stack structure can include a cathode layer between the first end and the second end. The stack structure can include an anode tab on the first area of the first end. The anode tab can be electrically coupled with the anode layer to define at least part of a negative terminal. The stack structure can include a cathode tab on the second area of the second end. The cathode tab can be electrically coupled with the cathode layer to define at least part of a positive terminal.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a cross-sectional view of an electric vehicle installed with a battery pack;

FIG. 2A depicts a block diagram of a battery pack for powering an electric vehicle;

FIG. 2B depicts a block diagram of a set of battery modules of a battery pack in an electric vehicle;

FIG. 3 depicts an overhead view of anode and cathode layers of a stack structure for a battery cell of a battery module;

FIG. 4 depicts a block diagram of anode and cathode layers forming a stack structure of a battery cell of a battery module;

FIG. 5 depicts an isometric view of a stack structure for a battery cell;

FIG. 6 depicts a head-on view of a first end of a stack structure for a battery cell defining positive and negative terminals;

FIG. 7 depicts a head-on view of a second end of a stack structure for a battery cell defining positive and negative terminals;

FIG. 8 depicts a head-on view of a spanning end of a stack structure for a battery cell;

FIG. 9 depicts an isometric view of a housing for a battery cell;

FIG. 10 depicts an exploded view of a battery module for holding a battery cell;

FIG. 11 depicts a method of assembling a battery cell; and

FIG. 12 depicts a method of providing a battery cell.

### DETAILED DESCRIPTION

Following below are more detailed descriptions of various concepts related to, and implementations of, a battery cell with a stack structure with diagonally positioned anode and cathode tabs. The various concepts introduced above and discussed in greater detail below may be implemented in any of numerous ways.

A battery cell can store and provide electrical power to any number of components, such as electrical or electromechanical devices in a vehicle. The battery cell can be of a prismatic structure and can include a stack structure (sometimes herein referred to as a jelly roll) comprising a series of alternating anode and cathode layers. Under one arrangement, the battery cell can have an anode tab along one side and a cathode tab along an opposite side. The anode tab can be electrically coupled with the anode layers in the stack structure and can define a negative terminal to draw in electrical current for the battery cell. The cathode tab can be electrically coupled with the cathode layers in the stack structure and can define a positive terminal to convey the electrical current for the battery cell. The anode and cathode tabs can occupy a small area of their respective sides of the battery cell.

This type of arrangement for the prismatic battery cell can present technical challenges. For example, it may be difficult to manage mechanical coupling between the battery cells and other components, such as a current carrier (also referred to herein as a bus bar or internal bus bar, among others). Since the anode and cathode tabs are located on their respective sides, it may be difficult to weld or form internal connections between the current carriers with the respective tabs, leading to stretching or damaging of tabs during the welding process. The current carrier architecture can become more complicated, with double stack configurations and thicker battery cells. The collection of tabs at a single location on each respective side may result in inconsistent current production, with the electric current traversing the shortest path along one side of the battery cell. This can lead to non-uniform usage of the cathode and anode layers and formation of a temperature differential throughout the battery cell. Inconsistent current production can be a challenge when the anode and cathode tabs form a small portion of the corresponding sides of the battery cell.

To address these and other problems, the stack structure of the battery cell can be split into two or more sections, with each section of the stack structure having an inverse arrangement with a diagonally opposite tab configuration. In the battery cell, a first section of the stack structure can have an anode tab on a first side toward a first edge and a cathode tab on an opposite second side toward a second edge. A second section of the stack structure can have an anode tab on the first side toward a second edge and a cathode tab on the second side toward the first edge, forming a diagonally opposite tab configuration (e.g., in an “x” shape). The anode and cathode tabs can be formed on a portion of on the corresponding side, such that an area is defined between the anode and cathode tabs.

By arranging the sections of the stack structure in this manner, the mechanical coupling between the battery cells with the current carrier can be easier to handle. For instance, thinner sections of the stack structure and by extension thinner tabs can be welded or folded together against the current carrier without stretching or damaging the tabs. The battery cell with such a stack configuration may avoid complex bus bar structures, as a single, thick bus bar can be incorporated to match the high-capacity cell specifications. In addition, the diagonally opposite side tab arrangement can result in a more uniform electromechanical current production, because the electrical current flows in a diagonal manner through the battery cell. The uniformity in turn can lead to uniform temperature distribution throughout the battery cell, thereby increasing the life span of the battery cell.

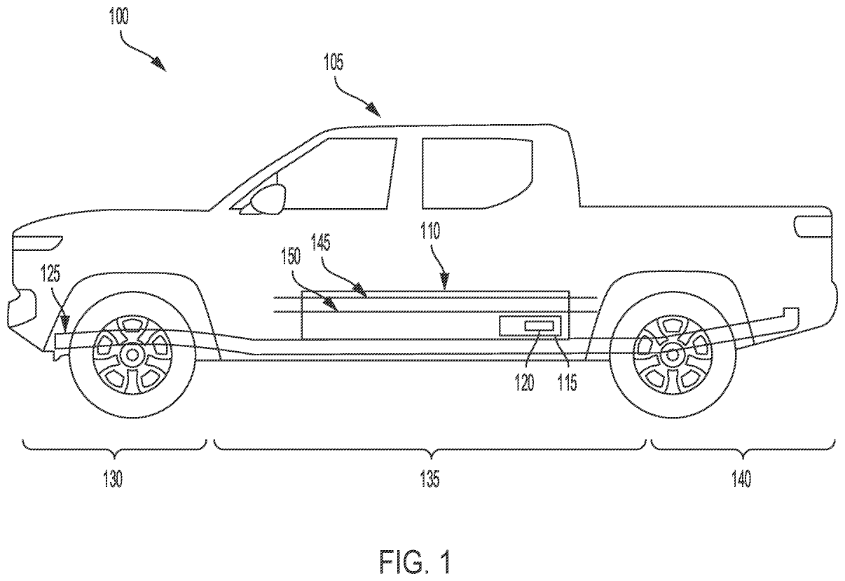

FIG. 1 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

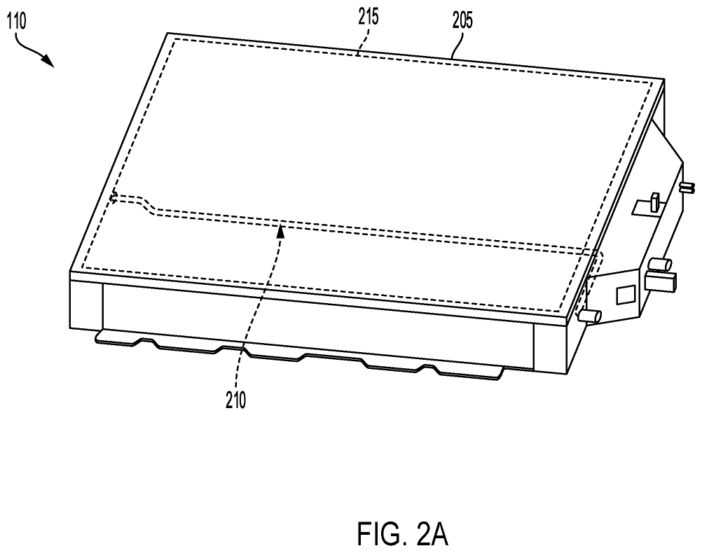

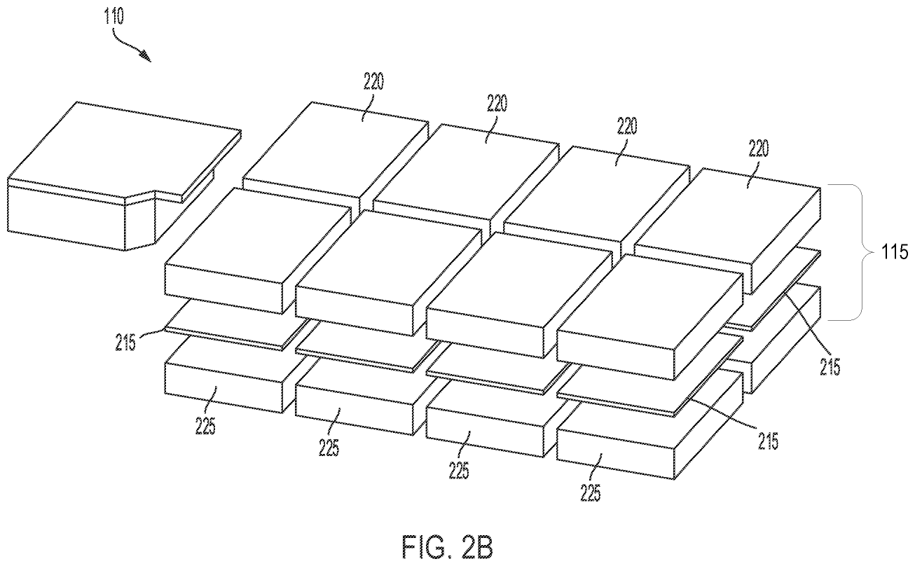

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one cold plate 215. The cold plate 215 can be positioned in relation to a top submodule and a bottom submodule, such as in between the top and bottom submodules, among other possibilities. The battery pack 110 can include any number of cold plates 215. For example, there can be one or more cold plates 215 per battery pack 110, or per battery module 115. At least one cooling line 210 can be coupled with, part of, or independent from the cold plate 215.

FIG. 2B depicts example battery modules 115. The battery modules 115 can include at least one submodule. For example, the battery modules 115 can include at least one first (e.g., top) submodule 220 or at least one second (e.g., bottom) submodule 225. At least one cold plate 215 can be disposed between the top submodule 220 and the bottom submodule 225. For example, one cold plate 215 can be configured for heat exchange with one battery module 115. The cold plate 215 can be disposed or thermally coupled between the top submodule 220 and the bottom submodule 225. One cold plate 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

The battery cell 120 can be included in battery modules 115 or battery packs 110 to power components of the electric vehicle 105. The battery cell 120 can include lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode.

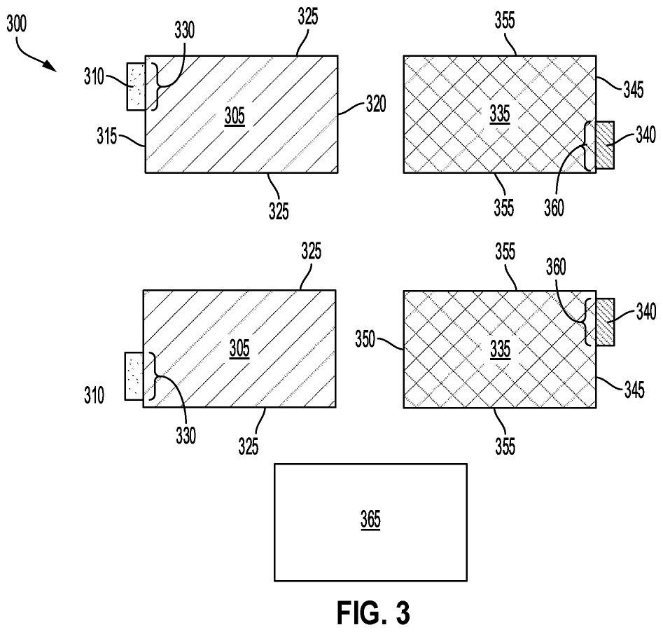

FIG. 3 depicts an overhead view of a stack structure 300 for the battery cell 120 of the battery module 115. The stack structure 300 can form, be a part of, or otherwise be included in the battery cell 120. The stack structure 300 can store and provide electrical energy, such as to power various components of the electrical vehicle 105. The stack structure 300 can be for a battery cell of any type, such as a lithium-ion battery cell, a nickel-zinc battery cell, a zinc-bromine battery cell, a zinc-cerium battery cell, a sodium-sulfur battery cell, or a nickel-cadmium battery cell, among others. The stack structure 300 can be of any shape and dimension. For example, the stack structure 300 can be prismatic, with a circular, elliptical, rectangular (e.g., as depicted), square, pentagonal, or a polygonal base, among others. The stack structure 300 can have a length (or height) ranging between 25-500 mm. The stack structure 300 can have a width ranging between 25-500 mm. The stack structure 300 can have a thickness ranging between 2-50 mm.

The stack structure 300 can include a set of anode layers 305. Each anode layer 305 can receive or draw electrical current into the battery cell 120 and output electrons during the operation of the battery cell 120 (e.g., charging or discharging of the battery cell 120). The anode layer 305 can include an active substance, such as graphite (e.g., activated carbon or infused with conductive materials), lithium titanate (Li₄Ti₅O₁₂), or a silicon-based material (e.g., silicon carbide), among others. The anode layer 305 can be of any shape, such as a rectangle (e.g., as depicted), square, circle, ellipse, pentagon, or hexagon, among others. The dimensions of the anode layers 305 can be the same or different in the stack structure 300. The anode layer 305 can have a length (or height) ranging between 25-500 mm. The anode layer 305 can have a width ranging between 15-250 mm. The anode layer 305 can have a thickness ranging between 1-5 mm.

The stack structure 300 can include at least one anode tab 310 for each corresponding anode layer 305. Each anode tab 310 can define at least a portion of a negative terminal for the battery cell 120 formed by the stack structure 300. The anode tab 310 can receive or draw electrical current into the battery cell 120 and output electrons during the operation of the battery cell 120 (e.g., charging or discharging of the battery cell 120). The anode tab 310 can be electrically coupled with the anode layer 305 to receive the electrical current during the operation of the battery cell 120. The anode tab 310 can be of any shape, such as a rectangle (e.g., as depicted), square, circle, ellipse, pentagon, or hexagon, among others. The dimensions of the anode tabs 310 can be the same or different among the anode layers 305 in the stack structure 300. The anode tab 310 can have a length (or height) ranging between 5-100 mm. The anode tab 310 can have a width ranging between 5-100 mm. The anode tab 310 can have a thickness ranging between 1-2.5 mm.

The arrangement of the anode tab 310 on the anode layer 305 can differ within the stack structure 300. With respect to the anode tab 310, each anode layer 305 can have at least one tab edge 315, at least one non-tab edge 320, and one or more adjacent edges 325. The tab edge 315 can correspond to a side (e.g., corresponding to the width) of the anode layer 305 along which the anode tab 310 can be positioned, situated, or otherwise arranged. The non-tab edge 320 can correspond to a side of the anode layer 305 opposite of the tab edge 315. Each adjacent edge 325 can correspond to a side (e.g., corresponding to the length) adjoining or intersecting the tab edge 315, and can lack or be free of the anode tab 310. The tab edge 315 can have at least one adjoining portion 330 with which the anode tab 310 can be an integral part of the anode layer 305, or can be welded, bonded, attached, joined, or otherwise mechanically coupled. The anode tab 310 can extend from the adjoining portion 330 on the tab edge 315. The adjoining portion 330 can be generally positioned, situated, or otherwise located towards the adjacent edge 325 of the anode layer 305. For a subset of anode layers 305 in the stack structure 300, the adjoining portion 330 and the anode tab 310 on the adjoining portion 330 can be along one non-tab edge 320. For another subset of anode layers 305, the adjoining portion 330 and the anode tab 310 on the adjoining portion 330 can be along another non-tab edge 320. In the depicted example, the anode layer 305 on the left set can have the anode tab 310 toward the top edge, whereas the anode layer 305 on the right set can have the anode tab 310 toward the bottom edge.

The stack structure 300 can include a set of cathode layers 335 (e.g., a composite cathode layer, a compound cathode layer, a compound cathode, a composite cathode, or a cathode). Each cathode layer 335 can output electrical current from the battery cell 120 and can receive electrons during the discharging of the battery cell 120. The cathode layer 335 can also release lithium ions during the discharging of the battery cell 120. Conversely, the cathode layer 335 can draw or receive electrical current into the battery cell 120 and can output electrons during the charging of the battery cell 120. The cathode layer 335 can receive lithium ions during the charging of the battery cell 120. The cathode layer 335 can be of any shape, such as a rectangle (e.g., as depicted), square, circle, ellipse, pentagon, or hexagon, among others. The dimensions of the cathode layers 335 can be the same or different in the stack structure 300. The cathode layer 335 can have a length (or height) ranging between 25-500 mm. The cathode layer 335 can have a width ranging between 25-500 mm. The cathode layer 335 can have a thickness ranging between 1-5 mm.

The stack structure 300 can include at least one cathode tab 340 for each corresponding cathode layer 335. Each cathode tab 340 can define at least a portion of a positive terminal for the battery cell 120 formed by the stack structure 300. The cathode tab 340 can output electrical current from the battery cell 120 and can receive electrons during the discharging of the battery cell 120. The cathode tab 340 can be an integral part of the cathode layer 335, or can be welded, bonded, attached, joined, or otherwise mechanically coupled with a side of the cathode layer 335. The cathode tab 340 can be electrically coupled with the anode layer 305 to receive the electrical current during the operation of the battery cell 120. The cathode tab 340 can be of any shape, such as a rectangle (e.g., as depicted), square, circle, ellipse, pentagon, or hexagon, among others. The dimensions of the cathode tabs 340 can be the same or different among the cathode layers 335 in the stack structure 300. The cathode tab 340 can have a length (or height) ranging between 5-100 mm. The cathode tab 340 can have a width ranging between 15-250 mm. The cathode tab 340 can have a thickness ranging between 1-5 mm.

The arrangement of the cathode tab 340 on the cathode layer 335 can differ within the stack structure 300. With respect to the cathode tab 340, each cathode layer 335 can have at least one tab edge 345, at least one non-tab edge 350, and one or more adjacent edges 355. The tab edge 345 can correspond to a side (e.g., corresponding to the width) of the cathode layer 335 along which the cathode tab 340 can be positioned, situated, or otherwise arranged. The non-tab edge 350 can correspond to a side of the cathode layer 335 opposite of the tab edge 345 and can lack or be free of the cathode tab 340. Each adjacent edge 355 can correspond to a side (e.g., corresponding to the length) adjoining or intersecting the tab edge 345, and can lack or be free of the cathode tab 340. The tab edge 345 can have at least one adjoining portion 360 with which the cathode tab 340 can be welded, bonded, attached, joined, or otherwise mechanically coupled. The cathode tab 340 can extend from the adjoining portion 360 on the tab edge 345. The adjoining portion 360 can be generally positioned, situated, or otherwise located towards the adjacent edge 355 of the cathode layer 335. For a subset of cathode layers 335 in the stack structure 300, the adjoining portion 360 and the cathode tab 340 on the adjoining portion 360 can be along one non-tab edge 350. For another subset of cathode layers 335 in the stack structure 300, the adjoining portion 360 and the anode tab 310 on the adjoining portion 360 can be along another non-tab edge 350. In the depicted example, the cathode layer 335 on the left set can have the cathode tab 340 toward the bottom edge, whereas the cathode layer 335 on the right set can have the cathode tab 340 toward the top edge.

The stack structure 300 can include a set of electrolyte layers 365. In the stack structure 300, each electrolyte layer 365 can be disposed, situated, or arranged between one anode layer 305 and an adjacent cathode layer 335. The electrolyte layer 365 can be situated between the anode layer 305 and the adjacent cathode layer 335. The electrolyte layer 365 can transfer cations from the anode layer 305 to the cathode layer 335 during the operation of the battery cell 120. The electrolyte layer 365 can transfer anions (e.g., lithium ions) from the cathode layer 335 to the anode layer 305 during the operation of the battery cell 120. The electrolyte layer 365 can be of any shape, such as a rectangle (e.g., as depicted), square, circle, ellipse, pentagon, or hexagon, among others. The dimensions of the electrolyte layers 365 can be the same or different in the stack structure 300. The electrolyte layer 365 can have a length (or height) ranging between 25-500 mm. The electrolyte layer 365 can have a width ranging between 25-500 mm. The electrolyte layer 365 can have a thickness ranging between 1-5 mm.

The electrolyte layer 365 can comprise any material to transfer cations between the anode layer 305 and the cathode layer 335. The electrolyte layer 365 can include or be made of a liquid electrolyte material. The liquid electrolyte material can include a lithium salt dissolved in a solvent. The lithium salt for the liquid electrolyte material for the electrolyte layer 365 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 365 can include or be made of a solid electrolyte material, such as a ceramic electrolyte material, polymer electrolyte material, or a glassy electrolyte material, or among others, or any combination thereof. The ceramic electrolyte material for the electrolyte layer 365 can include, for example, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The polymer electrolyte material (e.g., a hybrid or pseudo-solid state electrolyte) for electrolyte layer 365 can include, for example, polyacrylonitrile (PAN), polyethylene oxide (PEO), polymethyl-methacrylate (PMMA), and polyvinylidene fluoride (PVDF), among others. The glassy electrolyte material for the electrolyte layer 365 can include, for example, lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅), among others.

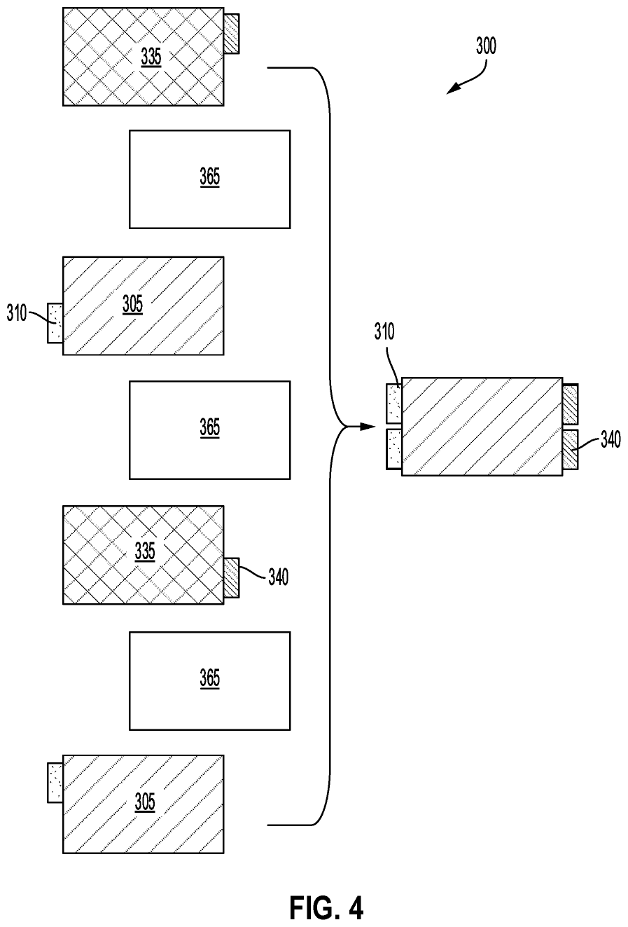

FIG. 4 depicts a block diagram of the set of anode layers 305, the set of cathode layers 335, and the set of electrolyte layers 365 forming the stack structure 300 of the battery cell 120 for the battery module 115. Within the stack structure 300, the set of anode layers 305 and the set of cathode layers 335 be disposed, arrayed, or otherwise arranged in an alternating manner, such that the anode tabs 310 and the cathode tabs 340 can be in an diagonal arrangement (e.g., in the form of an “x” structure). Each electrolyte layer 365 can be disposed, arranged, or situated between each pair of one anode layer 305 and one cathode layer 335. The stack structure 300 can have sections defining the arrangement of the anode tabs 310 and the cathode tabs 340. Depending on the section within the stack structure 300, at least anode layer 305 can have the anode tab 310 arranged along one side (e.g., toward left top side as depicted for the anode layer 305 on top). Conversely, at least one other anode layer 305 can have the anode tab 310 arranged along the opposite side (e.g., toward bottom right side as depicted for the anode layer 305 on bottom). Likewise, depending on the section within the stack structure 300, at least cathode layer 335 can have the cathode tab 340 arranged along one side (e.g., toward left top side as depicted for the anode layer 305 on top). Conversely, at least one other cathode layer 335 can have the cathode tab 340 arranged along the opposite side (e.g., toward bottom right side as depicted for the cathode layer 335 on bottom). With this arrangement, the stack structure 300 can have the anode tabs 310 and the cathode tabs 340 positioned diagonally across from each other.

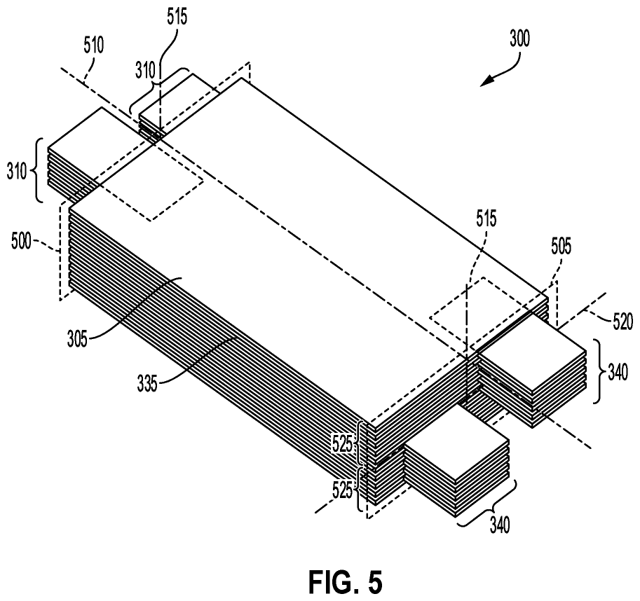

FIG. 5 depicts an isometric view of the stack structure 300 for the battery cell 120. The stack structure 300 can have at least one first end 500 and at least one second end 505 (e.g., anode tab end and cathode tab end respectively). The first end 500 and the second end 505 can correspond to sides of the stack structure 300 on which the anode tabs 310 and the cathode tabs 340 are arranged respectively. The first end 500 the second end 505 can correspond to the tab edges 315 the anode layers 305 and non-tab edges 320 of the cathode layers 335. The second end 505 can correspond to the tab edges 345 of the cathode layers 335 and the non-tab edges 350 of the anode layers 305. On the stack structure 300, the second end 505 can be opposite of the first end 500. In the depicted example, the first end 500 can correspond to a far side of the stack structure 300 and the second end 505 can correspond to a near side of the stack structure 300. The first end 500 and the second end 505 can be substantially parallel to each other (e.g., within +/−15% deviation). Both the set of anode layers 305 and the set of cathode layers 335 can be disposed, arrayed, or otherwise arranged between the first end 500 and the second end 505. Each anode layer 305 and each cathode layer 335 can traverse, cross, or otherwise span between the first end 500 and the second end 505.

The arrangement of various portions of the stack structure 300, including the first end 500 and the second end 505, can be defined relative to at least one first axis 510 (e.g., a longitudinal axis), at least one second axis 515 (e.g., a vertical or normal axis), and at least one third axis 525 (e.g., a lateral axis). The first axis 510 can cross, traverse, or otherwise span between the first end 500 and the second end 505. The first axis 510 can be substantially orthogonal (e.g., within +/−15% deviation) with a plane formed by the first end 500 or the second end 505. The first axis 510 can be substantially parallel (e.g., within +/−15% deviation) with a plane formed by at least one of the anode layers 305, the cathode layers 335, or the electrolyte layers 365 between the first end 500 and the second end 505.

Continuing on, the second axis 515 can cross, traverse, or otherwise span between one side (e.g., a top side) and another side (e.g., a bottom side) of the first end 500 and the second end 505. The second axis 515 can be substantially be substantially parallel (e.g., within +/−15% deviation) with the plane formed by the first end 500 or the second end 505. The second axis 515 can be substantially orthogonal (e.g., within +/−15% deviation) with the plane formed by at least one of the anode layers 305, the cathode layers 335, or the electrolyte layers 365 between the first end 500 and the second end 505. The third axis 520 can cross, traverse, or otherwise span from one side (e.g., left side) to another side (e.g., right side) of the first end 500 or the second end 505. The third axis 520 can be substantially parallel (e.g., within +/−15% deviation) with a plane formed by the first end 500 or the second end 505. The third axis 515 can be substantially orthogonal (e.g., within +/−15% deviation) with the plane formed by at least one of the anode layers 305, the cathode layers 335, or the electrolyte layers 365 between the first end 500 and the second end 505. The first axis 510, the second axis 515, and the third axis 520 can be substantially orthogonal (e.g., within +/−15% deviation) with one another.

On the first end 500, the set of anode tabs 310 can define or otherwise form the negative terminal for the battery cell 120. On the second end 505, the set of cathode tabs 340 can define or otherwise form the positive terminal for the battery cell 120. The arrangement of the anode tabs 310 and the cathode tabs 340 can be defined relative to the first axis 510 and the second axis 515. Relative to the first axis 510, the anode tabs 310 on one side (e.g., the first end 500) can be diagonally, obliquely, or transversely aligned with the cathode tabs 340 on the opposite side (e.g., the second end 505). In the depicted example, the anode tabs 310 on the first end 500 can be diagonally aligned with the cathode tabs 340 on the second end 505 in relation to the first axis 510. Conversely, the cathode tabs 340 on the second end 505 can be diagonally aligned with the anode tabs 310 on the first end 500 in relation to the first axis 510. Relative to the second axis 515, the anode tabs 310 on one side (e.g., the first end 500) can be diagonally (e.g., as depicted), obliquely, or transversely aligned with the cathode tabs 340 on the same side (e.g., the second end 505).

The stack structure 300 can have a set of sections 525. Each section 525 can include a subset of anode layers 305 along with the coupled anode tabs 310, a subset of cathode layers 335 along with the cathode tabs 340, and a subset of electrolyte layers 365. Each section 525 can correspond to a contiguous group of anode layers 305 along with the coupled anode tabs 310 on one end (e.g., the first end 500 or the second end 505), cathode layers 335 along with the cathode tabs 340 on the opposite end (e.g., the first end 500 or the second end 505), and electrolyte layers 365. One section 525 can be bordering, next to, or otherwise adjacent to another section 525. Each section 525 can be of any shape and dimension. For example, the section 525 can be prismatic, with a circular, elliptical, rectangular (e.g., as depicted), square, pentagonal, or a polygonal base, among others. The section 525 can have a length (or height) ranging between 25-500 mm. The section 525 can have a width ranging between 25-500 mm. The section 525 can have a thickness ranging between 1-25 mm.

In the stack structure 300, the set of sections 525 can be defined relative to the first axis 510. A boundary between one section 525 and another section 525 can be defined relative to a plane formed by the first axis 510 (or both one of the anode layers 305, cathode layers 335, or the electrolyte layer 365). The plane formed by the first axis 510 can be substantially parallel (e.g., within +/−15% deviation) with one of the anode layers 305, cathode layers 335, or the electrolyte layer 365 in the stack structure 300. In the depicted example, the stack structure 300 can have one section 525 above a plane defined by the first axis 510 and another section 525 below the plane defined by the first axis 510. The section 525 above the first axis 510 (e.g., the top half section) can have a subset of anode layers 305 along with the coupled anode tabs 310 on the first end 500 toward one non-tab edge 325, a subset of cathode layers 335 along with the cathode tabs 340 on the second end 505 toward another non-tab edge 355, and a subset of electrolyte layers 365. The section 525 below the first axis 510 (e.g., the bottom half section) can have a subset of anode layers 305 along with the coupled anode tabs 310 on the first end 500 toward opposite non-tab edge 325, a subset of cathode layers 335 along with the cathode tabs 340 on the second end 505 toward the opposite non-tab edge 355, and a subset of electrolyte layers 365.

While depicted with anode tabs 310 on the first end 500 and the cathode tabs 340 on the second end 505, the stack structure 300 can include the first end 500 and the second 505 each including anode tabs 310 and cathode tabs 340. For example, the section 525 above the first axis 510 (e.g., the top half section) can have a subset of anode layers 305 along with the coupled anode tabs 310 on the first end 500 toward one non-tab edge 325, a subset of cathode layers 335 along with the cathode tabs 340 on the second end 505 toward another non-tab edge 355, and a subset of electrolyte layers 365. The section 525 below the first axis 510 (e.g., the bottom half section) can have a subset of anode layers 305 along with the coupled anode tabs 310 on the second end 505 toward opposite non-tab edge 325, a subset of cathode layers 335 along with the cathode tabs 340 on the first end 500 toward the opposite non-tab edge 355, and a subset of electrolyte layers 365. The anode tabs 310 on the first end 500 can be diagonally aligned with the cathode tabs 340 on the first end 500 in relation to the second axis 515. Conversely, the anode tabs 310 on the second end 505 can be diagonally aligned with the cathode tabs 340 on the second end 505 in relation to the second axis 515.

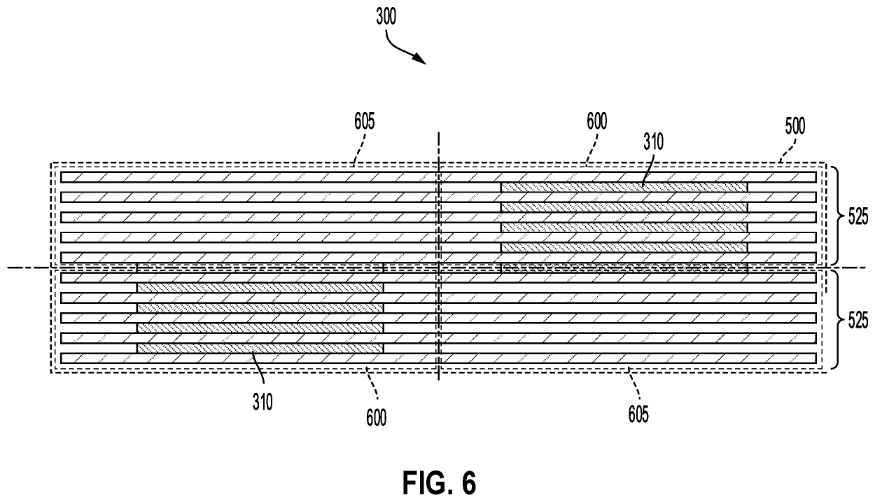

FIG. 6 depicts a head-on view of the first end 500 of the stack structure 300 for the battery cell 120 defining the positive and negative terminals. In each section 525 of the stack structure 300, the first end 500 can have at least one tab area 600 (sometimes herein generally referred to as a first area). The tab area 600 can correspond to a part of the first end 500 in a respective section 525 in which the set of anode tabs 310 is located, situated, or otherwise arranged. In the depicted example, the tab area 600 in the section 525 toward the top portion of the stack structure 300 can correspond to the right portion of the first end 500 in which the set of anode tabs 310 are located. The tab area 600 in the section 525 toward the bottom portion of the stack structure 300 can correspond to the left portion of the first end 500 in which the set of anode tabs 310 are located.

The tab area 600 can define a terminal in the first end 500 of the section 525. The set of anode tabs 310 of the section 525 can be positioned, situated, or otherwise arranged on at least a portion of the tab area 600 of the first end 500. The set of anode tabs 310 can occupy a portion (e.g., as depicted) or all of the tab area 600 in the first end 500. The portion of the tab area 600 occupied by the set of anode tabs 310 can range between 10-50%, for example. Other percentages outside this range, e.g., greater than 50%, are also possible. The tab area 600 itself can be of any shape, such as a rectangle (e.g., as depicted), square, circle, ellipse, pentagon, or hexagon, among others. The dimensions of the tab areas 600 can be the same or different among the set of sections 525 in the stack structure 300.

In addition, the first end 500 in each section 525 can have at least one tab-free area 605 (sometimes herein generally referred to as a second area). The tab-free area 605 can correspond to a part of the first end 500 in a respective section 525 without or lacking any set of anode tabs 310 for the respective section 525. The tab-free area 605 can correspond to a part of the first end 500 in the section 525 that is not the tab area 600 or outside the tab area 600 in the first end 500. The tab area 600 and the tab-free area 605 together can define or form the respective section 525 in the first end 500. In the depicted example, the tab-free area 605 in the section 525 toward the top portion of the stack structure 300 can correspond to the left portion of the first end 500 lacking the set of anode tabs 310. The tab-free area 605 in the section 525 toward the bottom portion of the stack structure 300 can correspond to the right portion of the first end 500 lacking the set of anode tabs 310. In each section 525, the tab area 600 and the tab-free area 605 can together form the first end 500.

The tab-free area 605 can be free of any terminal in the first end 500 of the section 525. The set of anode tabs 310 of the section 525 can be positioned, situated, or otherwise arranged outside of the tab-free area 605, and in the tab area 600. The tab-free area 605 itself can be of any shape, such as a rectangle (e.g., as depicted), square, circle, ellipse, pentagon, or hexagon, among others. The dimensions of the tab-free areas 605 can be the same or different among the set of sections 525 in the stack structure 300. The portion of the first end 500 free from the set of anode tabs 310 corresponding to the tab-free area 605 can range between 50-90%, for example. Other percentages outside this range, e.g., less than 50%, are also possible.

Between adjacent sections 525 of the first end 500, the tab areas 600 and the tab-free areas 605 can be diagonally (e.g., as depicted), obliquely, or otherwise transversely arranged, situated, or otherwise located relative to one another. The tab area 600 of one section 525 can be diagonally positioned from the tab area 600 of an adjacent section 525. A portion of a side of the tab area 600 in one section 525 can overlap with a portion of a side of the tab area 600 in the adjacent section 525. The sides of the tab areas 600 between adjacent sections 525 can lack overlap (e.g., as depicted). Likewise, the tab-free area 605 of one section 525 can be diagonally positioned from the tab-free area 605 of an adjacent section 525. A portion of a side of the tab-free area 605 in one section 525 can overlap with a portion of a side of the tab-free area 605 in the adjacent section 525. The sides of the tab-free areas 605 between adjacent sections 525 can lack overlap (e.g., as depicted).

Furthermore, the tab area 600 of one section 525 and the tab-free area 605 of the adjacent section 525 can be laterally arranged, situated, or otherwise aligned relative to each other (e.g., as depicted). For example, the tab area 600 of the section 525 toward the top of the stack structure 300 can be generally positioned on top of the tab-free area 605 of the section 525 toward the bottom of the stack structure 300. The tab-free area 605 of the section 525 toward the top of the stack structure 300 can be generally positioned on top of the tab area 600 of the section 525 toward the bottom of the stack structure 300. A portion of a side of the tab area 600 in one section 525 can overlap with at least a portion (e.g., or in full as depicted) of a side of the tab-free area 605 in the adjacent section 525. Conversely, a portion of a side of the tab-free area 605 in one section 525 can overlap with at least a portion (e.g., or in full as depicted) of a side of the tab area 600 in the adjacent section 525.

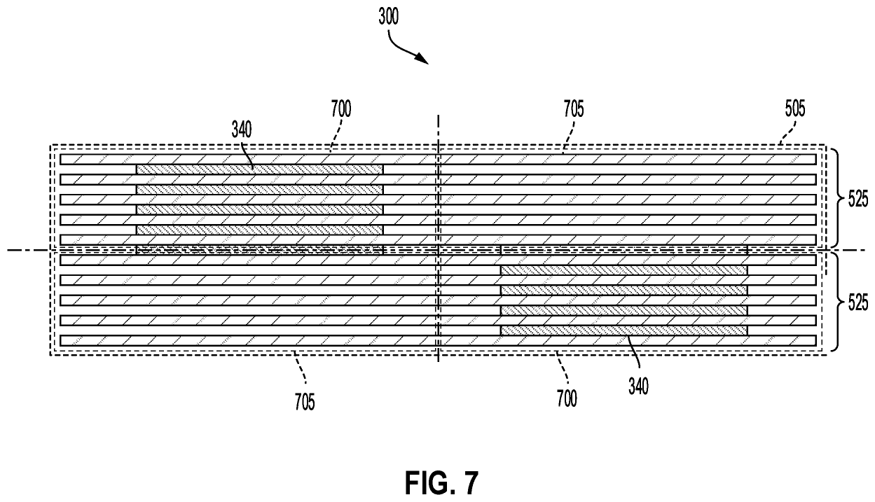

FIG. 7 depicts a head-on view of the second end 505 of the stack structure 300 for the battery cell 120 defining the positive and negative terminals. The components of the stack structure 300 on the second end 505 can be a reflection or a mirror of the components of the stack structure 300 on the first end 500. In each section 525 of the stack structure 300, the second end 505 can have at least one tab area 700 (sometimes herein generally referred to as a first area). The tab area 700 can correspond to a part of the second end 505 in a respective section 525 in which the set of cathode tabs 340 for the respective section 525 is located, situated, or otherwise arranged. In the depicted example, the tab area 700 in the section 525 toward the top portion of the stack structure 300 can correspond to the left portion of the second end 505 in which the set of cathode tabs 340 are located. The tab area 700 in the section 525 toward the bottom portion of the stack structure 300 can correspond to the right portion of the second end 505 in which the set of cathode tabs 340 are located.

The tab area 700 can define a terminal in the second end 505 of the section 525. The set of cathode tabs 340 of the section 525 can be positioned, situated, or otherwise arranged on at least a portion of the tab area 700 of the second end 505. The set of cathode tabs 340 can occupy a portion (e.g., as depicted) or all of the tab area 700 in the second end 505. The portion of the tab area 700 occupied by the set of cathode tabs 340 or the set of cathode tabs 340 can range between 10-50%, for example. Other percentages outside this range, e.g., greater than 50%, are also possible. The tab area 700 itself can be of any shape, such as a rectangle (e.g., as depicted), square, circle, ellipse, pentagon, or hexagon, among others. The dimensions of the tab areas 700 can be the same or different among the set of sections 525 in the stack structure 300.

In addition, the second end 505 in each section 525 can have at least one tab-free area 705 (sometimes herein generally referred to as a second area). The tab-free area 705 can correspond to a part of the second end 505 in a respective section 525 without or lacking any of the set of cathode tabs 340 for the respective section 525. The tab-free area 705 can correspond to a part of the second end 505 in the section 525 that is not the tab area 700 or outside the tab area 700 in the second end 505. The tab area 700 and the tab-free area 705 together can define or form the respective section 525 in the first end 700. In the depicted example, the tab-free area 705 in the section 525 toward the top portion of the stack structure 300 can correspond to the left portion of the second end 505 lacking the set of cathode tabs 340. The tab-free area 705 in the section 525 toward the bottom portion of the stack structure 300 can correspond to the right portion of the second end 505 lacking the set of cathode tabs 340. In each section 525, the tab area 700 and the tab-free area 705 can together form the second end 505.

The tab-free area 705 can be free of any terminal in the second end 505 of the section 525. The set of cathode tabs 340 of the section 525 can be positioned, situated, or otherwise arranged outside of the tab-free area 705, and in the tab area 700. The tab-free area 705 itself can be of any shape, such as a rectangle (e.g., as depicted), square, circle, ellipse, pentagon, or hexagon, among others. The dimensions of the tab-free areas 705 can be the same or different among the set of sections 525 in the stack structure 300. The portion of the first end 500 free from the set of cathode tabs 340 corresponding to the tab-free area 705 can range between 50-90%, for example. Other percentages outside this range, e.g., less than 50%, are also possible.

Between adjacent sections 525 of the second end 505, the tab areas 700 and the tab-free areas 705 can be diagonally (e.g., as depicted), obliquely, or otherwise transversely arranged, situated, or otherwise located relative to one another. The tab area 700 of one section 525 can be diagonally positioned from the tab area 700 of an adjacent section 525. A portion of a side of the tab area 700 in one section 525 can overlap with a portion of a side of the tab area 700 in the adjacent section 525. The sides of the tab areas 700 between adjacent sections 525 can lack overlap (e.g., as depicted). Likewise, the tab-free area 705 of one section 525 can be diagonally positioned from the tab-free area 705 of an adjacent section 525. A portion of a side of the tab-free area 705 in one section 525 can overlap with a portion of a side of the tab-free area 705 in the adjacent section 525. The sides of the tab-free areas 705 between adjacent sections 525 can lack overlap (e.g., as depicted).

Furthermore, the tab area 700 of one section 525 and the tab-free area 705 of the adjacent section 525 can be laterally arranged, situated, or otherwise aligned relative to each other (e.g., as depicted). For example, the tab area 700 of the section 525 toward the top of the stack structure 300 can be generally positioned on top of the tab-free area 705 of the section 525 toward the bottom of the stack structure 300. The tab-free area 705 of the section 525 toward the top of the stack structure 300 can be generally positioned on top of the tab area 700 of the section 525 toward the bottom of the stack structure 300. A portion of a side of the tab area 700 in one section 525 can overlap with at least a portion (e.g., or in full as depicted) of a side of the tab-free area 705 in the adjacent section 525. Conversely, a portion of a side of the tab-free area 705 in one section 525 can overlap with at least a portion (e.g., or in full as depicted) of a side of the tab area 700 in the adjacent section 525.

The tab area 700 and the tab-free area 705 on the second end 505 can be situated, positioned, or otherwise arranged relative to the tab area 600 and the tab-free area 605 on the first end 500 across the set of sections 525. In each section 525 of the stack structure 300, the tab area 600 of the first end 500 can be positioned, arranged, or otherwise aligned with the tab-free area 705 of the second end 505. The alignment between the tab area 600 of the first end 500 and the tab-free area 705 of the second end 505 can be along an axis defined relative to the first axis 510 (e.g., substantially parallel, within +/−15% deviation). With the alignment, the tab area 600 of the first end 500 can be positioned, situated, or otherwise located opposite of the tab-free area 705 of the second end 505. Likewise, for each section 525, the tab-free area 605 of the first end 500 can be positioned, arranged, or otherwise aligned with the tab area 700 of the second end 505. The alignment between the tab-free area 605 of the first end 500 and the tab area 700 of the second end 505 can be along an axis defined relative to the first axis 510 (e.g., substantially parallel, within +/−15% deviation). With the alignment, the tab-free area 605 of the first end 500 can be positioned, situated, or otherwise located opposite of the tab area 700 of the second end 505.

Arranged in this manner, the set of anode tabs 310 on the tab area 600 of the first end 500 can be arranged, situated, or otherwise positioned on a diagonal axis relative to the set of cathode tabs 340 on the tab area 700 of the second end 505. Conversely, the set of cathode tabs 340 on the tab area 700 of the second end 505 can be arranged, situated, or otherwise positioned on a diagonal axis relative to the set of anode tabs 310 on the tab area 600 of the first end 500. The diagonal axis can be oblique relative or intersecting to the first axis 510 defined between the first end 500 and the second end 505. During operation of the battery cell 120, the arrangement of the set of anode tabs 310 and the set of cathode tabs 340 can permit transfer, delivery, or otherwise conveyance of electric current between the negative terminal and the positive terminal along the diagonal axis. In addition, the arrangement of the set of anode tabs 310 and the set of cathode tabs 340 can permit dispersal, spreading, or otherwise distribution of thermal energy (and by extension heat) through the stack structure 300.

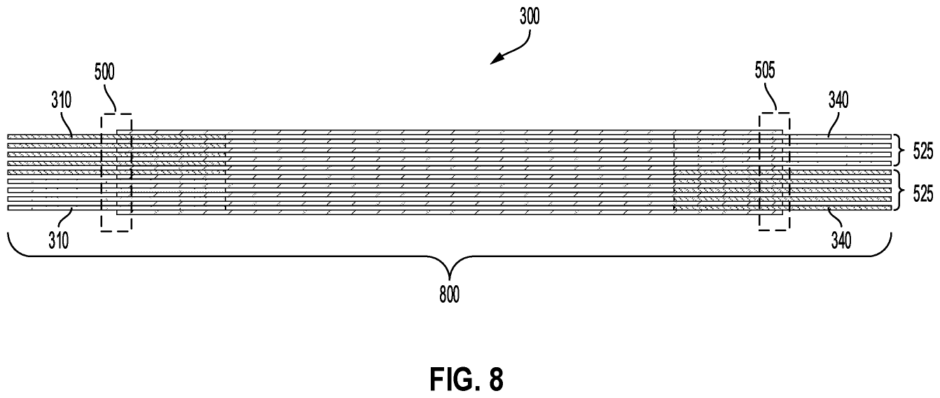

FIG. 8 depicts a head-on view of a spanning side 800 of the stack structure 300 for the battery cell 120. The spanning side 800 can correspond to a portion (e.g., a lateral portion) of the stack structure 300 between the first end 500 and the second end 505. The spanning side 800 can correspond to a side of the stack structure 300 without any anode tabs 310 or cathode tabs 340 extending therefrom. The spanning side 800 can include the set of anode layers 305, the set of cathode layers 335, and the set of electrolyte layers 365 arranged in an alternating manner. The spanning side 800 can correspond to one of the adjacent edges 325 of the anode layers 305, the adjacent edges 355 of the cathode layers 335, and edges of the electrolyte layers 365.

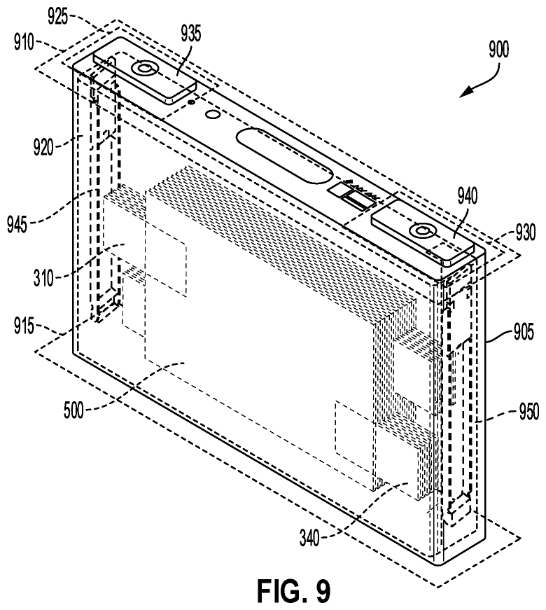

FIG. 9 depicts an isometric view of a housing 900 for the stack structure 300 of the battery cell 120. The battery cell 120 can include at least one housing 900 within which to dispose, arrange, or otherwise include the stack structure 300. The housing 900 can be of any shape and dimension, and can follow the shape of the stack structure 300. For example, the housing 900 can be prismatic, with a circular, elliptical, rectangular (e.g., as depicted), square, pentagonal, or a polygonal base, among others. The housing 900 can have a length ranging between 30-700 mm. The housing 900 can have a width ranging between 30-700 mm. The housing 900 can have a height (or thickness) ranging between 4-100 mm.

The housing 900 for the battery cell 120 can include one or more materials with various electrical conductivity or thermal conductivity, or a combination thereof. The housing 900 can include portions that are electrically conductive and other portions that are thermally conductive and electrically insulative. The electrically conductive and thermally conductive material for the housing 900 can include a metallic material, such as aluminum, an aluminum alloy with copper, silicon, tin, magnesium, manganese or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 900 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The housing 900 can have at least one sidewall 905 (e.g., a longitudinal surface, side, wall, or covering). The sidewall 905 can form an integral portion of the housing 900. The sidewall 905 can correspond to a longitudinal side of the housing 900. The sidewall 905 can extend or span between one lateral side and the opposite lateral side of the housing 900. The sidewall 905 can cover or shield a longitudinal portion of the contents within the housing 900, such as the stack structure 300 for the battery cell 120. The sidewall 905 can comprise one or more electrically insulative and thermally conductive materials, such as a ceramic or a thermoplastic. The dimensions of the sidewall 905 can correspond to the dimensions of the overall housing 900.

The housing 900 can have at least one first side 910 and at least one second side 915. Each of the first side 910 and the second side 915 can correspond to one lateral end of the housing 205, such as a top side (e.g., as depicted for the first side 910), a bottom side (e.g., as depicted for the second side 915), a left side, or a right side. Each of the first side 910 and the second side 915 can at least partially span the lateral end of the housing 900. Both the first side 910 and the second side 915 can be a separate from the housing 900, and then added to the corresponding lateral side of the housing 900 on the sidewall 905. Both the first side 910 and the second side 915 can cover or shield a lateral portion of the contents within the housing 900, such as the stack structure 300. The first side 910 and the second side 915 can comprise an electrically insulative and thermally conductive material, such as a ceramic or a thermoplastic. The dimensions of the first side 910 and the second side 915 can correspond to the dimensions of the overall housing 900.

The housing 900 can define or have at least one cavity 920. Contents of the housing 900 (e.g., the stack structure 300 for the battery cell 120) can be stored, contained, or otherwise included within the cavity 920. The cavity 920 can correspond an empty hollowing, space, region, or volume within the housing 900. The stack structure 300 for the battery cell 120 can be disposed, situated, or arranged within the cavity 920. The cavity 920 can be defined by the sidewall 905, the first side 910, and the second side 915. The cavity 920 can be defined by the sidewall 905 along on one axis (e.g., a longitudinal axis) and the first side 910 and the second side 915 on another axis. The cavity 920 can span between the first side 910 and the second side 915. One end of the cavity 920 can correspond to the first side 910 and the opposite end of the cavity 920 can correspond to the second side 915. The cavity 920 can be of any shape and dimension, and can follow the shape of the stack structure 300. The cavity 920 can be prismatic, with a circular, elliptical, rectangular (e.g., as depicted), square, pentagonal, or a polygonal base, among others.

On at least one of the first side 910 or the second side 915, the housing 900 can define or have at least one negative terminal region 925 and at least one positive terminal region 930 (generally referred to as a first region and a second region respectively). The negative terminal region 925 can correspond to a portion of a respective side (e.g., the first side 910 and the second side 915) defining at least a portion of one of the polarity terminals (e.g., positive or negative terminal). The positive terminal region 930 can correspond to the respective side (e.g., the first side 910 and the second side 915) defining at least a portion of the opposite polarity terminal (e.g., positive or negative terminal). For example, as depicted, the negative terminal region 925 can define the negative terminal on the first side 910. The positive terminal region 930 can define the positive terminal on the first side 910. The negative terminal region 925 and the positive terminal region 930 each can be of any shape, such as a rectangle (e.g., as depicted), square, circle, ellipse, pentagon, or hexagon, among others. The negative terminal region 925 and the positive terminal region 930 can be one side of the housing 900 while not the other. For example, as depicted, the first side 910 can have the negative terminal region 925 and the positive terminal region 930, whereas the second side 915 can lack the negative terminal region 925 and the positive terminal region 930.

Both the first side 910 and the second side 915 can have the negative terminal region 925 and the positive terminal region 930. For example, between the two ends, the negative terminal region 925 on the first side 910 can be laterally positioned, situated, or otherwise aligned with the positive terminal region 930 of the second side 915. Conversely, the positive terminal region 930 on the first side 910 can be laterally positioned, situated, or otherwise aligned with the negative terminal region 925 of the second side 915. The alignment of the negative terminal regions 925 and the positive terminal regions 930 on the first side 910 and the second side 915 can be defined relative to the axes of the stack structure 300, such as the first axis 510 and the second axis 515. The negative terminal region 925 on the first side 910 can be arranged, situated, or otherwise aligned diagonally to the positive terminal region 930 on the second side 915. The positive terminal region 930 on the first side 910 can be arranged, situated, or otherwise aligned diagonally to the negative terminal region 925 on the second side 915.

The stack structure 300 can be disposed, arranged, or situated within the cavity 920 of the housing 900. With respect to the stack structure 300 within the cavity 920, the negative terminal region 925 can be can be arranged, situated, or otherwise aligned with the first end 500 of the stack structure 300. For example, the negative terminal region 925 on the first side 910 can be aligned with the tab area 600 in the first end 500 of the stack structure 300 in one section 525. The negative terminal region 925 can be electrically coupled (e.g., using a conductive wire welded, bonded, attached, joined, or otherwise mechanically coupled) with the set of anode tabs 310 on the first end 500. The positive terminal region 930 can be arranged, situated, or otherwise aligned with the second end 505 of the stack structure 300. For example, the positive terminal region 930 on the first side 910 can be aligned with the tab area 700 in the second end 505 of the stack structure 300 in one section 525. The positive terminal region 930 can be electrically coupled (e.g., using a conductive wire welded, bonded, attached, joined, or otherwise mechanically coupled) with the set of cathode tabs 340 on the second end 505.

The housing 900 can have at least one negative terminal structure 935 and at least one positive terminal structure 940 on the first side 910 (e.g., as depicted) or the second side 915. The negative terminal structure 935 can be arranged, situated, or otherwise positioned within at least a portion of the negative terminal region 925. The positive terminal structure 940 can be arranged, situated, or otherwise positioned within at least a portion of the positive terminal region 930. Both the negative terminal structure 935 and the positive terminal structure 940 can comprise an electrically conductive material. For example, the negative terminal structure 935 and the positive terminal structure 940 can correspond to an exposed metallic portion on each of the first side 910 and the second side 915. The negative terminal structure 935 and the positive terminal structure 940 each can be of any shape and dimension. For example, the negative terminal structure 935 and the positive terminal structure 940 each can be prismatic, with a circular, elliptical, rectangular (e.g., as depicted), square, pentagonal, or a polygonal base, among others.

Within the cavity 920, the housing 900 can include at least one anode tab connector element 945 and at least one cathode tab connector element 950. The anode tab connector element 945 and the cathode tab connector element 950 can at least partially span between the first side 910 and the second side 915 of the housing 900. Each of the anode tab connector element 945 and cathode tab connector element 950 can comprise an electrical conductive material, such as a metallic material, such as aluminum, an aluminum alloy with copper, silicon, tin, magnesium, manganese or zinc (e.g., aluminum 1000, 4000, or 5000 series), iron, an iron-carbon alloy (e.g., steel), silver, nickel, copper, and a copper alloy, among others. For example, as depicted, both the anode tab connector element 945 and the cathode tab connector element 950 can be metallic clip-like structures connected to the set of anodes 310 and the set of cathodes 340 respectively.

The anode tab connector element 945 can electrically couple at least one of the anode tabs 310 along the first end 505 of the stack structure 300 with the negative terminal structure 935. The anode tab connector element 945 can be can be welded, bonded, attached, joined, or otherwise mechanically coupled with the set of anode 310. The anode tab connector element 945 can be can be welded, bonded, attached, joined, or otherwise mechanically coupled with the negative terminal region 925 or the negative terminal structure 935. In addition, the cathode tab connector element 950 and the cathode tab connector element 950 can at least partially span between the first side 910 and the second side 915 of the housing 900. The cathode tab connector element 950 can electrically couple at least one of the cathode tabs 340 along the second end 510 of the stack structure 300 with the negative terminal structure 940. The cathode tab connector element 950 can be can be welded, bonded, attached, joined, or otherwise mechanically coupled with the set of anode 310. The cathode tab connector element 950 can be can be welded, bonded, attached, joined, or otherwise mechanically coupled with the positive terminal region 930 or the positive terminal structure 940.

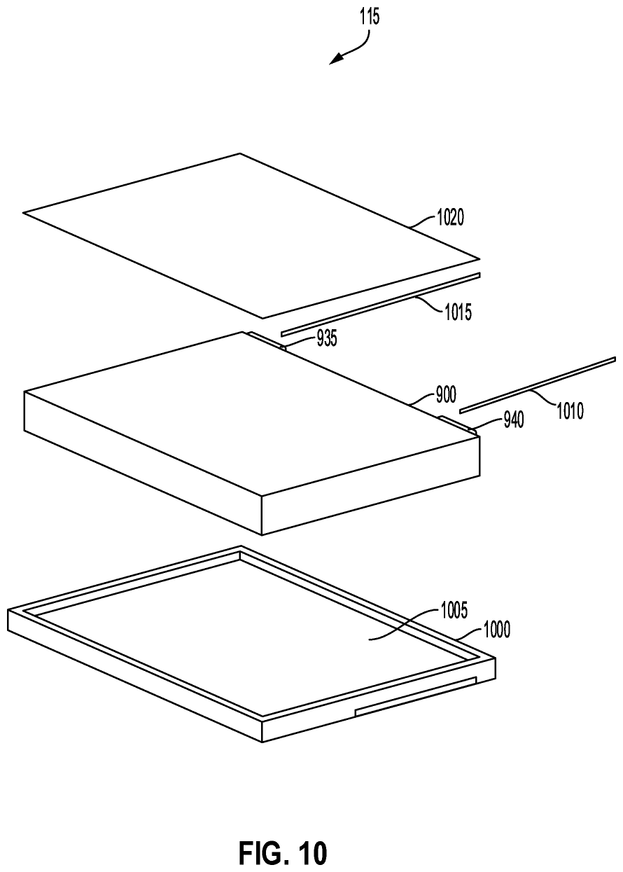

FIG. 10 depicts an exploded view of the battery module 115 for holding the battery cell 120. The battery module 115 can have at least one container 1000 (sometimes herein referred to as a battery case or holder). The container 1000 can form an integral portion of the battery module 115. The container 1000 can correspond to sides of the battery module 115, forming sidewalls and a base for the battery module 115. The container 1000 can extend or span between one lateral side and the opposite lateral side of the battery module 115. The container 1000 can also cover or shield at least one longitudinal portion of the contents within the battery module 115, such as the housing 900 for the battery cell 120. The container 1000 can comprise one or more electrically insulative and thermally conductive materials, such as a ceramic or a thermoplastic. The dimensions of the container 1000 can correspond to the dimensions of the battery module 115 or the overall battery module 115.

The container 1000 for the battery module 115 can have at least one cavity 1005. Contents of the battery module 115 (e.g., the housing 900 for the battery cell 120) can be stored, contained, or otherwise included within the cavity 1005. The cavity 1005 can correspond an empty hollowing, space, region, or volume within the container 1000. The housing 900 for the battery cell 120 can be disposed, situated, or arranged within the cavity 1005. The cavity 1005 can be defined by a sidewall and a base of the container 1000. The cavity 1005 can have an opening alone one side through which the housing 900 can be place or inserted into the container 1000. The cavity 1005 can be of any shape and dimension, and can follow the shape of the stack structure 300. The cavity 1005 can be prismatic, with a circular, elliptical, rectangular (e.g., as depicted), square, pentagonal, or a polygonal base, among others.

The battery module 115 can contain, house, otherwise include at least one first current carrier 1010 (e.g., a first bus bar or a first internal bus bar) on the first side 910 (e.g., as depicted) or the second side 915 of the housing 900. In addition, the battery module 115 may contain, house, or otherwise include and at least one second current carrier 1015 (e.g., a second bus bar or second internal bus bar) on the first side 910 (e.g., as depicted) or the second side 915 of the housing 900. The first current carrier 1010 can be welded, bonded, attached, joined, or otherwise mechanically coupled with the negative terminal structure 935 of the housing 900. Coupled with the negative terminal structure 935, the first current carrier 1010 can be electrically coupled with the set of anode tabs 310 of the stack structure 300 along the first end 500. The second current carrier 1015 can be welded, bonded, attached, joined, or otherwise mechanically coupled with the positive terminal structure 940 of the housing 900. Coupled with the positive terminal structure 940, the second current carrier 1015 can be electrically coupled with the set of cathode tabs 340 of the stack structure 300 along the second end 505.

The first current carrier 1010 and the second current carrier 1015 can also electrically couple the battery cell 120 with one or more battery cells 120. The electrical coupling among the battery cells 120 via the first current carrier 1010 or the second current carrier 1015 can be in series, in parallel, or any combination thereof. The battery cells 120 electrically coupled via the first current carrier 1010 or the second current carrier 1015 can be in the same battery module 115 or within a different battery module 115. The first current carrier 1010 and the second current carrier 1015 can also electrically couple the battery cell 120 with one or more electrical components in the electric vehicle 105.

The battery module 115 can have at least one covering element 1020. The covering element 1020 can cover, secure, or otherwise hold the contents (e.g., the housing 900) of the battery module 115 within the container 1000. The covering element 1020 can be mechanically coupled (e.g., fastened, attached, welded, bonded, or glued) to the container 1000. The covering element 1020 can be mechanically coupled to one lateral end of the container 1000 (e.g., toward the opening). The covering element 1020 can be of any shape and dimension, and can be similar in shape to the container 1000 or the cavity 1005. The covering element 1020 can be prismatic, with a circular, elliptical, rectangular (e.g., as depicted), square, pentagonal, or a polygonal base, among others.

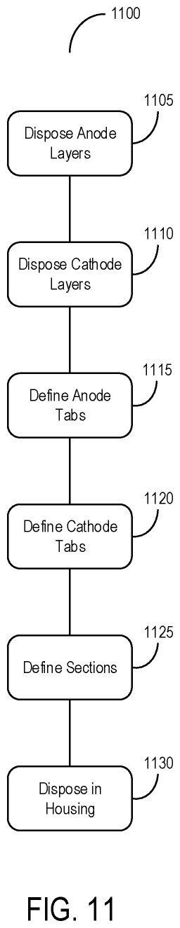

FIG. 11 depicts a method 1100 of assembling a battery cell 120. The method 1100 can include disposing a set of anode layers 305 (ACT 1105). Each anode layer 305 can draw electrical current into the battery cell 120 and output electrons during the operation of the battery cell 120, such as during the charging or discharging of the battery cell 120. Each anode layer 305 can be disposed in a stack structure 300 spanning between a first end 500 and a second end 505. The stack structure 300 can form the battery cell 120, and can store and provide electrical power to one or more components in the electrical vehicle 105.

The method 1100 can include disposing a set of cathode layers 335 (ACT 1110). Each cathode layer 335 can output electrical current from the battery cell 120 and can receive electrons during the discharging of the battery cell 120. Each cathode layer 335 can be disposed in the stack structure 300 between the first end 500 and the second end 505. The set of anode layers 305 and the set of cathode layers 335 can be arranged or arrayed in an alternating manner through the stack structure. Between each anode layer 305 and cathode layer 335, the stack structure 300 can have an electrolyte layer 365. The electrolyte layer 365 can transfer anions from the cathode layer 335 to the anode layer 305 during the operation of the battery cell 120.

The method 1100 can include defining a set of anode tabs 310 (ACT 1115). Each anode tab 310 can be defined on a respective anode layer 305 along a tab edge 315. At least one anode tab 310 can be defined on the tab area 600 of the first end 500. The tab area 600 of the first end 500 can be aligned with the tab-free area 705 of the second end 505. Each anode tab 310 can define at least a portion of a negative terminal for the battery cell 120 formed by the stack structure 300. The anode tab 310 can draw electrical current into the battery cell 120 and output electrons during the operation of the battery cell 120. The anode tab 310 can extend from an adjoining portion 330 of the tab edge 315 of the anode layer 305. The anode tab 310 can be welded, bonded, attached, joined, or otherwise mechanically coupled with a side of the anode layer 305.

The method 1100 can include defining a set of cathode tabs 340 (ACT 1120). Each cathode tab 340 can be defined on a respective cathode layer 335 along a tab edge 345. At least one cathode tab 340 can be defined on the tab area 700 of the second end 505. The tab area 700 on the second end 505 can be aligned with the tab-free area 605 of the first end 500. Each cathode tab 340 can define at least a portion of a positive terminal for the battery cell 120 formed by the stack structure 300. The cathode tab 340 can output electrical current from the battery cell 120 and can receive electrons during the discharging of the battery cell 120. The cathode tab 340 can be welded, bonded, attached, joined, or otherwise mechanically coupled with a side of the cathode layer 335. Arranged in this manner, the anode tab 310 on the first end 500 can be situated on a diagonal axis relative to the cathode tab 340 on the second end 505 to convey electric current between the negative and positive terminals along the diagonal axis.

The method 1100 can include defining the set of sections 525 in the stack structure 300 (ACT 1125). Each section 525 can include a subset of anode layers 305 along with the coupled anode tabs 310, a subset of cathode layers 335 along with the cathode tabs 340, and a subset of electrolyte layers 365. Between adjacent sections 525, the tab areas 600 and 700 and the tab-free areas 605 and 705 can be diagonally (e.g., as depicted), obliquely, or otherwise transversely arranged, situated, or otherwise located relative to one another on with the respective end 500 or 505. In addition, in each section 525 of the stack structure 300, the tab area 600 of the first end 500 can be positioned, arranged, or otherwise aligned with the tab-free area 705 of the second end 505. Conversely, the tab-free area 605 of the first end 500 can be positioned, arranged, or otherwise aligned with the tab area 700 of the second end 505.

The method 1100 can include disposing the stack structure 300 within the housing 900 (ACT 1130). The stack structure 300 can be disposed within the cavity 920 defined by the housing 900. The housing 900 can have the first side 910 and the second side 915. On each of the first side 910 and the second side 915, the housing 900 can define or have the negative terminal region 925 and the positive terminal region 930. The negative terminal structure 935 can be positioned within the negative terminal region 925. The negative terminal structure 935 can electrically couple the set of anode tabs 310 with the first current carrier 1010. The positive terminal structure 940 can be positioned within the positive terminal region 930. The positive terminal structure 940 can electrically couple the set of cathode tabs 340 with the second current carrier 1015.

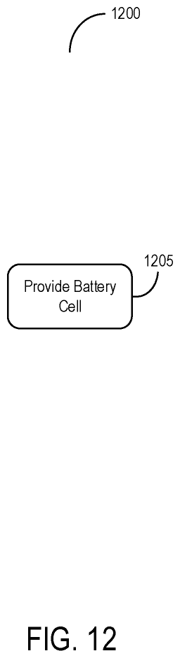

FIG. 12 depicts a method 1200 of providing the battery cell 120. The method 1200 can include providing the battery cell 120 (ACT 1205). The battery cell 120 can include the stack structure 300. The stack structure 300 can include the set of anode layers 305 and the set of cathode layers 335 between the first end 500 and the second end 505. In at least one section 525, the stack structure 300 can also have the set of anode tabs 310 on the tab area 600 of the first end 500 and the set of cathode tabs 340 on the tab area 700 of the second end 505. The tab area 600 of the first end 500 can be aligned with the tab-free area 705 of the second end 505 and the tab-free area 605 of the first end 500 can be aligned with the tab area 700 of the second end 505.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, the arrangement of the anode tabs 310 and the cathode tabs 340 can be mirrored or reversed in the stack structure 300. Elements described as negative elements can instead be configured as positive elements and elements described as positive elements can instead be configured as negative elements. For example, elements described as having first polarity can instead have a second polarity, and elements described as having a second polarity can instead have a first polarity. Further relative parallel, perpendicular, vertical or other positioning or orientation descriptions include variations within +/−15% or +/−15 degrees of pure vertical, parallel or perpendicular positioning. References to “approximately,” “substantially” or other terms of degree include variations of +/−15% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell, comprising:
a stack structure comprising a first end and a second end, the first end comprising a first area and a second area, a first area of the second end aligned with the first area of the first end and a second area of the second end aligned with the second area of the first end, the stack structure comprising:
an anode layer between the first end and the second end;
a cathode layer between the first end and the second end;
an anode tab on the first area of the first end, the anode tab electrically coupled with the anode layer to define at least part of a negative terminal; and
a cathode tab on the second area of the second end, the cathode tab electrically coupled with the cathode layer to define at least part of a positive terminal.

2. The battery cell of claim 1, comprising:
the stack structure including a plurality of sections, the plurality of sections including a first section and a second section, the first section including the anode layer, the cathode layer, the anode tab, and the cathode tab, the second section including:
a second anode layer between the first end and the second end;
a second cathode layer between the first end and the second end;
a second anode tab on the second area of the first end, the second anode tab electrically coupled with the second anode layer to define at least part of the negative terminal; and
a second cathode tab on the first area of the second end, the second cathode tab electrically coupled with the second cathode layer to define at least part of the positive terminal.

3. The battery cell of claim 1, comprising:
the stack structure including a plurality of sections, at least one of the plurality of sections including:
a plurality of anode layers between the first end and the second end in a corresponding section;
a plurality of cathode layers between the first and the second end in the corresponding section, the plurality of cathode layers alternating with the plurality of anode layers;
a plurality of anode tabs on the first area of the first end in the corresponding section, each of the plurality of anode tabs electrically coupled with a corresponding anode layer of the plurality of anode layers to define at least part of the negative terminal; and
a plurality of cathode tabs on the second area of the second end in the corresponding section, each of the plurality of cathode tabs electrically coupled with a corresponding cathode layer of the plurality of cathode layers to define at least part of the positive terminal.

4. The battery cell of claim 1, comprising:
a housing to define a cavity within which to dispose the stack structure, the housing including:
a first side and a second side, the first side comprising a first region and a second region, a first region of the second side aligned with the first region of the first end and a second region of the second side aligned with the second region of the first side;
a first structure on the first region of the first side, the first structure electrically coupled with the anode tab to define at least part of the negative terminal; and
a second structure on the second region of the second side, the second structure electrically coupled with the cathode tab to define at least part of the positive terminal.

5. The battery cell of claim 1, comprising:
the first end and the second end opposite of the first end, the first area of the second end aligned with the first area of the first end along a first axis defined between the first end and the second end, the second area of the second end aligned with the second area of the first end along a second axis defined between the first end and the second end, the first axis substantially parallel with the second axis.

6. The battery cell of claim 1, comprising:
the anode tab on the first area of the first end situated on a diagonal axis relative to the cathode tab situated on the second area of the second end to convey electric current between the negative terminal and the positive terminal along the diagonal axis in the stack structure.

7. The battery cell of claim 1, comprising:
the anode tab on the first area of the first end situated on a diagonal axis relative to the cathode tab situated on the second area of the second end to distribute thermal energy throughout the stack structure between the first end and the second end.

8. The battery cell of claim 1, comprising:
the anode tab to couple with a first current carrier to electrically couple the first current carrier with the anode layer, the cathode tab to couple with a second current carrier to electrically couple the second current carrier with the cathode layer.

9. The battery cell of claim 1, comprising:
the stack structure to store electric power to provide to at least one component of an electric vehicle.

10. A method, comprising:
disposing an anode layer between a first end and a second end of a stack structure;
disposing a cathode layer between the first end and the second end of the stack structure;
defining an anode tab on a first area of the first end aligned with a first area of the second end, the anode tab electrically coupled with the anode layer to define at least part of a negative terminal; and
defining a cathode tab on a second area of the second end aligned with a second area of the first tab, the cathode tab electrically coupled with the cathode layer to define at least part of a positive terminal.

11. The method of claim 10, comprising:
defining, in the stack structure, a plurality of sections, the plurality of sections comprising a first section and a second section, the first section comprising the anode layer, the cathode layer, the anode tab, and the cathode tab;
disposing a second anode layer between the first end and the second end in the second section of the stack structure;
disposing a second cathode layer between the first end and the second end in the second section of the stack structure;
defining a second anode tab on the second area of the first end aligned with the second area of the second end, the second anode tab electrically coupled with the second anode layer to define at least part of the negative terminal; and
defining a second cathode tab on the first area of the second end aligned with the first area of the first tab, the second cathode tab electrically coupled with the second cathode layer to define at least part of the positive terminal.

12. The method of claim 10, comprising defining, in the stack structure, a plurality of sections, at least one of the plurality of sections comprising:
a plurality of anode layers between the first end and the second end in a corresponding section;
a plurality of cathode layers between the first and the second end in the corresponding section, the plurality of cathode layers alternating with the plurality of anode layers;
a plurality of anode tabs on the first area of the first end in the corresponding section, each of the plurality of anode tabs electrically coupled with a corresponding anode layer of the plurality of anode layers to define at least part of the negative terminal; and
a plurality of cathode tabs on the second area of the second end in the corresponding section, each of the plurality of cathode tabs electrically coupled with a corresponding cathode layer of the plurality of cathode layers to define at least part of the positive terminal.

13. The method of claim 10, comprising:
disposing, within a cavity defined by a housing, the stack structure, the housing comprising a first side and a second side, the first side comprising a first region and a second region, a first region of the second side aligned with the first region of the first end and a second region of the second side aligned with the second region of the first side;
defining a first structure on the first region of the first side, the first structure electrically coupled with the anode tab to define at least part of the negative terminal; and
defining a second structure on the second region of the second side, the second structure electrically coupled with the cathode tab to define at least part of the positive terminal.

14. The method of claim 10, comprising:
coupling the anode tab with a first current carrier to electrically couple the first current carrier with the anode layer; and
coupling the cathode tab with a second current carrier to electrically couple the second current carrier with the cathode layer.

15. The method of claim 10, comprising:
situating the anode tab on the first area of the first end on a diagonal axis relative to the cathode tab situated on the second area of the second end to convey electric current between the negative terminal and the positive terminal along the diagonal axis in the stack structure.

16. An electric vehicle, comprising:
a battery pack to power one or more components of the electric vehicle;
a housing arranged in the battery pack, the housing defining a cavity;
a stack structure disposed in the housing, the stack structure comprising:
a first end and a second end, the first end including a first area and a second area, a first area of the second end aligned with the first area of the first end and a second area of the second end aligned with the second area of the first end;
an anode layer between the first end and the second end;
a cathode layer between the first end and the second end;
an anode tab on the first area of the first end, the anode tab electrically coupled with the anode layer to define at least part of a negative terminal; and
a cathode tab on the second area of the second end, the cathode tab electrically coupled with the cathode layer to define at least part of a positive terminal.

17. The electric vehicle of claim 16, comprising:
the stack structure including a plurality of sections, the plurality of sections comprising a first section and a second section, the first section comprising the anode layer, the cathode layer, the anode tab, and the cathode tab, the second section comprising:
a second anode layer between the first end and the second end;
a second cathode layer between the first end and the second end;
a second anode tab on the second area of the first end, the second anode tab electrically coupled with the second anode layer to define at least part of the negative terminal; and
a second cathode tab on the first area of the second end, the second cathode tab electrically coupled with the second cathode layer to define at least part of the positive terminal.

18. The electric vehicle of claim 16, wherein the stack structure comprises:
a plurality of anode layers between the first end and the second end in a corresponding section;
a plurality of cathode layers between the first and the second end in the corresponding section, the plurality of cathode layers alternating with the plurality of anode layers;
a plurality of anode tabs on the first area of the first end in the corresponding section, each of the plurality of anode tabs electrically coupled with a corresponding anode layer of the plurality of anode layers to define at least part of the negative terminal; and
a plurality of cathode tabs on the second area of the second end in the corresponding section, each of the plurality of cathode tabs electrically coupled with a corresponding cathode layer of the plurality of cathode layers to define at least part of the positive terminal.

19. The electric vehicle of claim 16, comprising:
the anode tab to couple a first current carrier with the anode layer; and
the cathode tab to couple a second current carrier with the cathode layer.

20. The electric vehicle of claim 16, comprising:
the housing comprising a first side and a second side, the first side comprising a first region and a second region, a first region of the second side aligned with the first region of the first end and a second region of the second side aligned with the second region of the first side, the housing comprising:
a first structure on the first region of the first side, the first structure electrically coupled with the anode tab to define at least part of the negative terminal; and
a second structure on the second region of the second side, the second structure electrically coupled with the cathode tab to define at least part of the positive terminal.
